(19) United States
(12) Patent Application Publication
(10) Pub. No.: US 2013/0312997 A1
(43) Pub. Date: Nov. 28, 2013

(54) ELECTRICAL BOX

(71) Applicant: ERICO International Corporation, Solon, OH (US)

(72) Inventors: Peter Barrett Korte, Bay Village, OH (US); Raymond Michael Olle, Broadview Heights, OH (US); Raymond Scott Laughlin, Middlefield, OH (US); Eric J. Wilson, Solon, OH (US); Edward J. Lynch, Akron, OH (US); Daniel S. Mominee, Chandler, AZ (US)

(73) Assignee: ERICO International Corporation, Solon, OH (US)

(21) Appl. No.: 13/900,005

(22) Filed: May 22, 2013

Related U.S. Application Data
(60) Provisional application No. 61/650,011, filed on May 22, 2012.

(51) Int. Cl. H02G 3/08

(52) U.S. Cl. CPC H02G 3/081
USPC 174/56

(57) ABSTRACT

An electrical box includes a box portion that surrounds a volume and has an at least partially open back, a mud ring that is coupled to the front of box portion, and structure mounts that extend out beyond a perimeter of the volume enclosed by the box portion. The structure mounts are used to couple to any of a variety of types of structure, such as a stud, an inter-stud bracket, or other structure. The structure mounts may include integral parts of the mud ring, integral parts of the box portion, or separate brackets that are attached to the box portion and/or the mud ring. Advantages for the electrical box include a reduced number of parts, reduced time and labor for installation, and flexibility in installation.

This application claims priority under 35 USC 119 to U.S. Provisional Application 61/650,011, filed May 22, 2012, which is incorporated by reference in its entirety.

### BACKGROUND OF THE INVENTION

1. Technical Field of the Invention

The invention is in the field of electrical boxes, and methods of using electrical boxes.

2. Description of the Related Art

Electrical boxes are widely used to mount electrical components, such as switches and outlets, and to contain electrical wiring connections. Installation and alignment of such boxing can be a time-consuming process.

Current common practice is for the electrician to build each individual electrical device assembly in the field, meaning the electrician will typically select a standard electrical box and install it behind the desired bracket or support, said bracket is typically mounted to or between the wall studs. Once the box has been placed behind the bracket, the electrician will install a mud-ring of the appropriate depth to the front of the bracket, covering the opening to the already installed electrical box, and sandwiching the bracket between the electrical box and mud-ring. The mud-ring will provide the mounting surface for the desired electrical device(s) (typically switches or receptacles), which are then installed into the body of the box itself, and secured to holes in the mud-ring. It should be apparent that there are a multiple of steps required to facilitate the typical installation of electrical devices when the assembly is “built” in the field.

Practice has evolved in recent years to a semi-prefabricated methodology, with apprentice electricians building the electrical assembly previously described off-site, and leaving a “pigtail” of cable dangling from an opening in the electrical box, with the box/device assembly pre-installed onto the appropriate bracketry. These prefabricated assemblies are then attached to the wall studs and the pigtail is connected to the appropriate circuit, completing the installation.

Lately the open-back box, invented some years ago, has recently gained popularity as a means to facilitate even easier prefabrication, since the open back allows an electrician access to easily make wiring connections to the electrical devices pre-installed in the assembly. However, that open-back box still required the separate, and prior, installation of a size-specific mud-ring to complete the install.

### SUMMARY OF THE INVENTION

This invention includes multiple embodiments and variations. According to one embodiment, an open-back electrical box has integral mounting brackets or similar means to effect attachment/mounting to a wall stud and an integral mud ring (as known as a “plaster ring”). This general embodiment is referred to herein as an “AlObox.” In another embodiment the AlObox also allows for adjustment into and out of the wall cavity by moving the box relative to a mounting bracket. Both embodiments are suitable for mounting a variety and multiplicity of electrical devices. The AlObox is preferred over a standard closed back electrical box for pre-fabrication applications where the desired electrical device (or combination of electrical devices) is (are) shipped installed into the electrical box directly from the factory. The integral mounting brackets allow for quick attachment to wall studs without requiring the installation of a secondary mounting bracket, and the integral mud-ring eliminates the need for the electrician to install the mud-ring in a separate operation, saving time during the installation.

Various embodiments of the AlObox described herein incorporate all of the benefits of the open-back box, they also may incorporate integral mounting brackets and an integral mud-ring to effect the quickest installation possible by eliminating all of the additional components typically required.

Conventional mud-rings are available in a variety of depths that correspond to the thickness of the drywall being used for a particular room. Depths range from a thin as 6.4 mm (0.25 inches) to an enormous 3.2 cm (1.25 inches) (used where double-thickness 1.6 cm (0.625 inches) drywall is installed for firewall applications), with the most common depths used being 1.6 cm (0.625 inches) and 1.9 cm (0.75 inches). Lately there have been a large number of inventions related to developing an adjustable mud ring that would eliminate the need to stock all of the depths listed previously. One embodiment of this invention incorporates an extended flange/throat that provides the same benefit as an adjustable mud-ring covering the full range of depths listed above, with the AlObox moving in or out relative to the wall bracket.

Among the myriad of issues with using conventional electrical boxes and mud-rings (and/or advantages of the open-back boxes described herein) are the following: it is time-consuming to build the assembly (box/bracket/mud-ring), and therefore costly; there are a number of different drywall thicknesses commonly installed on a given jobsite, requiring a contractor to stock a sufficient inventory of each depth mud-ring to meet the needs of that particular job; standard mud-rings are available in fixed increments, but there are times when a job might require a mud-ring in a depth that falls between those set increments (e.g., a kitchen installation that might include a grout and tile backsplash); for pre-fabricated assemblies, in the worst-case scenario a multiple of each assembly must be stocked to cover each mud-ring depth, in the best-case scenario at least the major depths of mud-rings must be stocked in multiple configurations (these require extra inventory at the manufacturing level as well as at distribution); conventional box/mud-ring/bracket assemblies have a myriad of gaps around the edges of the jointed surfaces which are an issue as they allow smoke and flame propagation during fires, while the AlObox, by virtue of the manufacturing methods employed, has no such gaps; existing box/bracket products currently in the market today do not allow mounting in any orientation, but only in certain specific orientations; existing pre-fab assemblies require the installer to know in advance which side of the stud they're mounting to—if the field install requires a change to the other side of the stud the pre-fab assembly must be disassembled and the devices rotated 180 degrees to correct the install; existing pre-fab assemblies are fairly fragile, the brackets are easily bent/deformed during shipping from the contractor's off-site facility to the jobsite.

According to an embodiment of the invention, an electrical box combines all of the benefits of the open-back box and an adjustable mud-ring into a single assembly, offering all of the novelty and time savings of the individual components to provide the fastest solution for prefabricating electrical assemblies.

According to another embodiment, an open-back electrical box has integral mounting brackets and an integral mud-ring incorporated into the face of the box. The box, with electrical devices previously installed, is able to be attached to a vertical stud with no additional bracketry required, and no further components (except a cover for the open-back of the box) must be attached to complete the installation.

According to other aspects of the invention, multiple of which may be combined in a single embodiment (as appropriate), an open-back electrical box has integral, or attachably detachable, mounting brackets; an open-back electrical box has an integral mud-ring; an extended integral mud-ring has the capability to cover the complete range of drywall thicknesses currently being installed in the commercial market (with, for example, the mud ring length being fixed and box moving for adjustment); a fixed box location and an extendable mud ring may cover the complete range of drywall thicknesses currently being installed in the commercial market; a box has the ability to make box adjustments in three dimensions (vertically along a stud face, horizontally between studs, and into or out of the wall cavity based on drywall thickness); a box has integrated mounting brackets/tabs means allowing for installation to a wall stud in any orientation without requiring additional bracketry; a box has opposing pairs of mounting brackets act as guide tabs allowing the assembly to either horizontal or vertical bracketry for between stud mounting applications; using fasteners facilitates the depth adjustment of an integral mud-ring or alternatively an adjustable box; using screws and/or springs provides resistance during the depth adjustment; a separate mounting flange attaches to common bracketry and serves as the mounting mechanism for the one-piece box with integral mud-ring; and/or a sliding wedge driven by a threaded fastener controls the depth of an adjustable integral mud-ring (note: existing T&B patent for adjustable mud ring).

According to further aspects of the invention, an electrical box includes: a box portion having an open or at least partially open back; one or more brackets for mounting the box portion to structure, such as a stud, an inter-stud bracket, or other structure; and a mud ring at least mechanically coupled to the box portion. The box may have one or more of the following additional features: the one or more brackets include at least two brackets; the two brackets are on opposite respective sides of the box portion; the mud ring is integrally formed with the box portion; the mud ring is fixedly attached to the box portion; the one or more brackets are fixedly attached to the box portion; the one or more brackets are integrally with the box portion; the one or more brackets are adjustable in position relative to the box portion; the box is in combination with an electrical device that is mechanically coupled to the mud ring; the electrical device is a receptacle; the electrical device is a switch; the electrical device has electrical wiring tails attached to it; the electrical wiring tails have respective electrical connectors on their ends; the combination of the electrical box and the electrical device is prefabricated prior to being transferred to an end user; the combination of the electrical box and the electrical device is fabricated away from a jobsite; the electrical box is made of steel; the electrical box is made of a polymeric material; the electrical box is made out of some combination of steel and polymeric material; the electrical box is made of out zinc, ferrous or non-ferrous materials; the electrical box can also be installed by the traditional methods; the electrical box may contain an extended integral mud-ring; and/or the electrical box may contain an extendable mud ring.

According to another aspect of the invention, an electrical box includes: a box portion having a closed back; one or more brackets for mounting the box portion to structure, such as a stud, an inter-stud bracket, or other structure; and a mud ring at least mechanically coupled to the box portion. The box may have one or more of the following additional features: the one or more brackets include at least two brackets; the two brackets are on opposite respective sides of the box portion; the mud ring is integrally formed with the box portion; the mud ring is fixedly attached to the box portion; the one or more brackets are fixedly attached to the box portion; the one or more brackets are integrally formed with the box portion; the one or more brackets are adjustable in position relative to the box portion; in combination with an electrical device that is mechanically coupled to the mud ring; the electrical device is a receptacle; the electrical device is a switch; the electrical device has electrical wiring tails attached to it; the electrical wiring tails have respective electrical connectors on their ends; the combination of the electrical box and the electrical device is prefabricated prior to being transferred to an end user; the combination of the electrical box and the electrical device is fabricated away from a jobsite; the electrical box is made of steel; the electrical box is made of a polymeric material; the electrical box is made out of some combination of steel and polymeric material; the electrical box is made of out zinc, ferrous or non-ferrous materials; the electrical box can also be installed by the traditional methods; the electrical box may contain an extended integral mud-ring; and/or the electrical box may contain an extendable mud ring.

According to still another aspect of the invention, a method of electrical installation at a jobsite includes: preparing the electrical box prior to installation at the jobsite by preinstalling an electrical device on a mud ring of the electrical box; installing the electrical box at the jobsite; and making electrical connections to the electrical device. The electrical box may have an open or at least partially open back, may contain one or more integrally formed brackets (or tabs) and an integrally formed mud ring, and may have one or more of the features of the previous paragraph.

According to a further aspect of the invention, an electrical box includes: a box portion having an at least partially open back; a mud ring non-threadedly coupled to a front of the box portion; and one or more structure mounts mechanically coupled to the box portion and/or to the mud ring, and extending beyond a perimeter of a volume surrounded by the box portion.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The annexed drawings, which are not necessarily to scale, show various aspects of the invention.

FIG. 1 is a first oblique view of an electrical box according to a first embodiment of the invention.

FIG. 2 is a second oblique view of the electrical box of FIG. 1.

FIG. 3 is a third oblique view of the electrical box of FIG. 1.

FIG. 4 is a fourth oblique view of the electrical box of FIG. 1.

FIG. 5 is an oblique view of an electrical box according to a second embodiment of the invention.

FIG. 6 is an exploded view of the electrical box of FIG. 5.

FIG. 7 is an oblique view of an electrical box according to a third embodiment of the invention.

FIG. 8 is a plan view, showing parts of the electrical box of FIG. 7.

FIG. 9 is an oblique view of an electrical box according to a fourth embodiment of the invention.

FIG. 10 is an exploded view of the electrical box of FIG. 9.

FIG. 11 is an oblique view of an electrical box according to a fourth embodiment of the invention.

FIG. 12 is a plan view, showing parts of the electrical box of FIG. 11.

FIG. 13 is an oblique view of an electrical box according to a sixth embodiment of the invention.

FIG. 14 is an exploded view of the electrical box of FIG. 13.

### DETAILED DESCRIPTION

An electrical box includes a box portion that surrounds a volume and has an at least partially open back, a mud ring that is coupled to the front of box portion, and structure mounts that extend out beyond a perimeter of the volume enclosed by the box portion. The structure mounts are used to couple to any of a variety of types of structure, such as a stud, an inter-stud bracket, or other structure. The structure mounts may include integral parts of the mud ring, integral parts of the box portion, or separate brackets that are attached to the box portion and/or the mud ring. Advantages for the electrical box include a reduced number of parts, reduced time and labor for installation, and flexibility in installation.

An AlObox with integral mounting brackets and integral mud-ring is an open-back electrical box with both the mounting brackets and the mud-ring already included with the box. The unit is intended to contain electrical devices (e.g., switches, receptacles) within a finished wall in commercial, residential, or industrial construction. It consists of a generally square box section of a prescribed volume with an opening on one end. Opposite the open end is a drawn flange that terminates into a mounting surface for a variety of electrical devices.

Where the mud-ring flange transitions to the flat front of the box the front has tabs, possibly on all four sides, that serve as mounting surfaces to effect attachment of the AlObox to a wall stud. These mounting surfaces (structure mounts) may be integral parts of either a mud ring or a box portion of the electrical box, or (in some embodiments) the structure mounts may be separate brackets that are attached to the box portion, for example. These same mounting tabs could be used in a second embodiment to serve as the attachment surface for the AlObox to a separate mounting bracket when in-wall depth adjustment is desired.

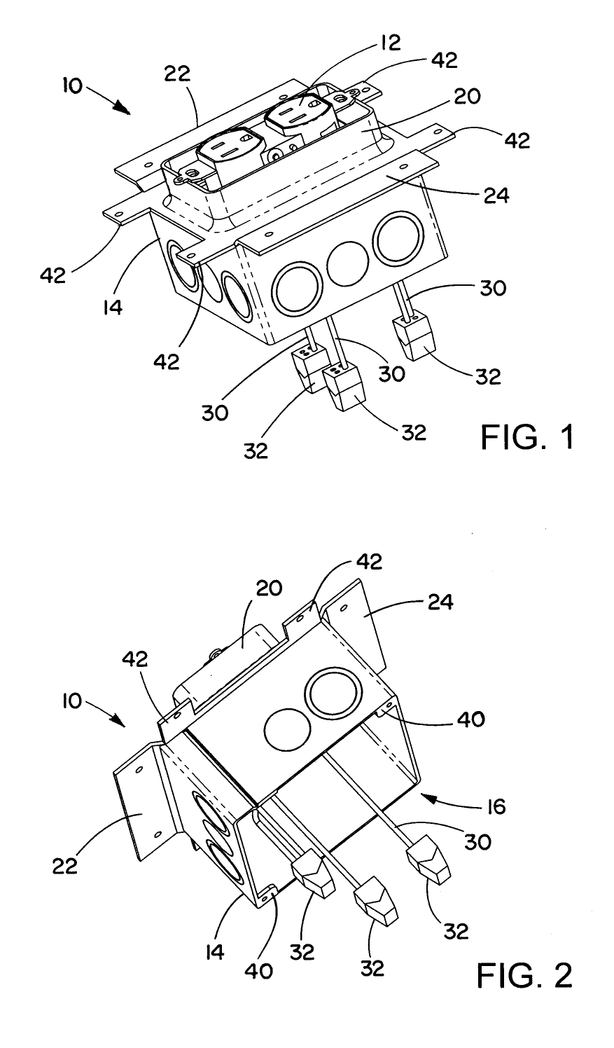

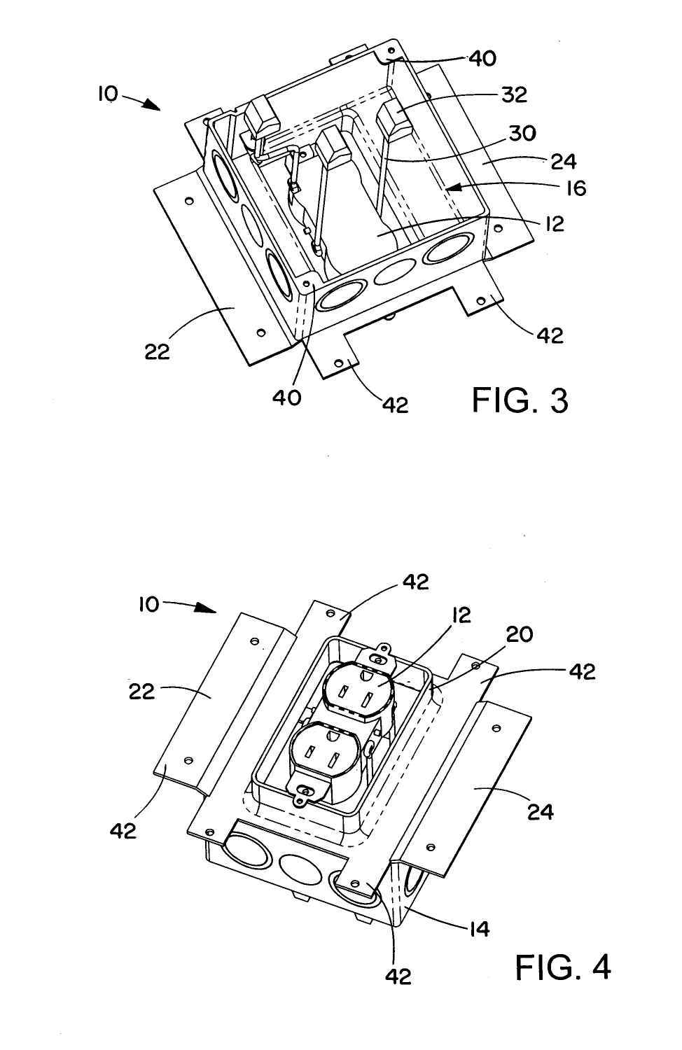

FIGS. 1-4 show an embodiment of an open-back electrical box 10 that is used to mount an electrical device 12, such as a receptacle (shown) or an electrical switch (not shown). The box 10 includes a box portion 14 with an open back 16. An integral mud ring 20 is on the front of the box 10. The mud ring 20 receives the receptacle or other electrical device 12, with a pair of tabs with threaded holes that receive screws to hold the electrical device 12 against the mud ring 20. The box 10 includes a pair of integral structure mounts 22 and 24 for mounting the box 10 to a stud or other structure. The structure mounts 22 and 24 have holes for receiving screws or other suitable fasteners for mounting to structure. With dual structure mounts 22 and 24 it is possible to mount the box 10 to either side of a stud, without the need for any disassembly.

The box 10 may come pre-fabricated with the receptacle or other device 12 already installed on the mud ring 20, and with wiring tails 30 already coupled to the mud ring 20. The tails 30 may have suitable connectors 32 for making electrical connection to electrical wiring where the box 10 is to be installed. The pre-fabrication of the box 10 allows for faster installation, and removes the need for electricians or other skilled and highly-paid personnel to fabricate box assemblies at a jobsite. After the box 10 is installed on structure, such as a stud, the electrical connections may be made within the box 10, using the pre-installed electrical connectors 32. A cover plate (not shown) may then be used to cover the open back 16 of the box portion 14. The cover plate may be mounted using threaded-hole back tabs 40 at corners (or other suitable locations) on the back side of the box portion 14.

The box 10 may be made of steel or another suitable material. Other possible materials for the box 10 include a polymeric material, a combination of steel and a polymeric material, zinc, ferrous or non-ferrous materials. The box 10 may be made out of a single piece of continuous material, or may have separate parts fixedly attached together, such as by welding, riveting, stamping, staking, or other suitable methods.

The box portion 14 may have any of a variety of shapes, such as square, rectangular, octagonal, or round, and may have any of a variety of depths. Suitable cutouts or knockouts may be provided in sides of the box portion to allow entry of electrical wires, cables, and connectors. The box portion may alternatively be configured for receiving multiple receptacles, either side-by-side or in a 2×2 or other array. The structure mounts 22 and 24 may have any of a variety of suitable shapes or configurations.

Tabs 42 are integrally formed with and a part of the front piece 116 or the box portion 124, and may be used for mounting, as an alternative to the structure mounts 22 and 24. Alternatively the tabs 42 may be mechanically fastened to other parts of the box 10. Such mechanically-fastened tabs should be considered as encompassed by the term “brackets” as used herein, including in the claims and in the summary of the invention. In general, the term “brackets” is used to denote a structure mount that is part of a separate piece, as opposed to being an integral part of a mud ring or a box portion. However, in some instances the term “bracket” is used herein with regard to an integral structure mount, a structure mount that is an integral part of (formed from the same unitary, continuous piece as) a mud ring or box portion, as opposed to the narrower reference to a bracket as a separate piece. Mechanical fastening of the tabs 42 to the box 10 may be accomplished through any of a wide variety of suitable mechanical fasteners, including threaded fasteners such as screws or bolts, and rivets.

The illustrated box 10 is an open-back box. For example the back of the box 10 may be at least 75% open, in that at least 75% of the area of the back face of the box portion 14 is open. The box 10 may be at least 90% open, or substantially fully open. The box 10 may alternatively have a partially-closed or substantially-completely-closed back. The same is true of other embodiments described herein.

In another embodiment (not shown) the box portion is adjustable relative to the mounting brackets, in order to adjust for different thicknesses of wall board, for example. The mounting brackets may be adjustable coupled to the box portion by any of a variety of mechanisms, including clips on the brackets and/or box portion that adjust the position of the bracket(s) relative to the box portion, or threaded fasteners and/or springs coupled to one or both of the brackets and the box portion, to give just two of many possibilities.

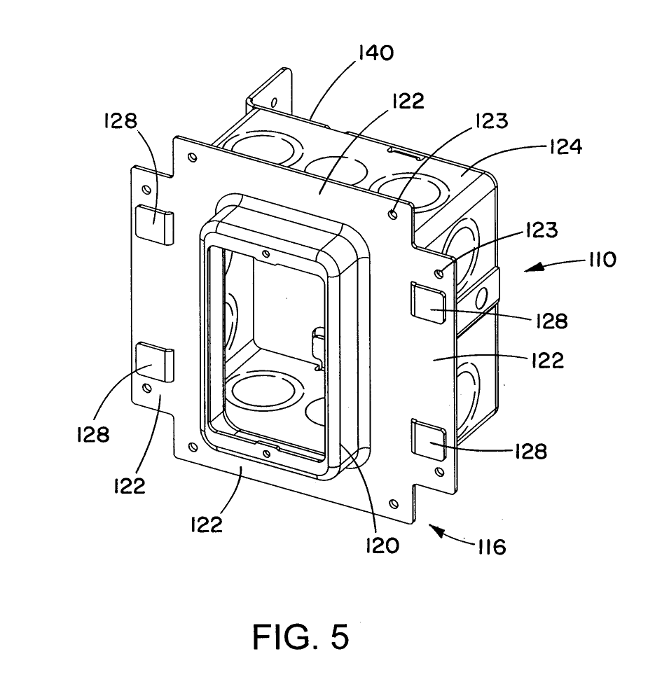

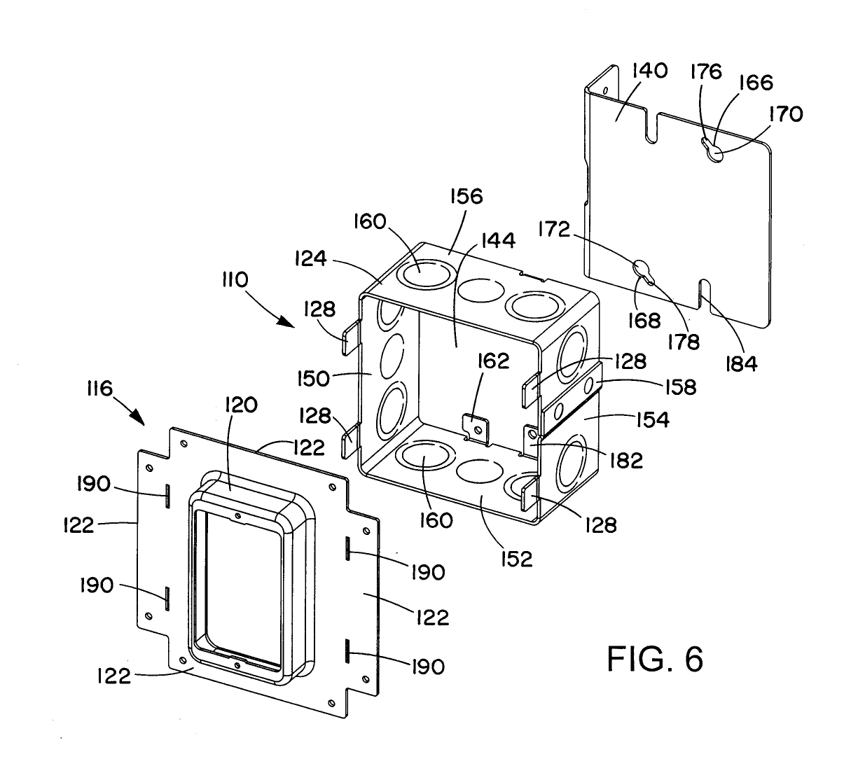

FIGS. 5-12 show embodiments that encompass some of these variants. FIGS. 5 and 6 show a box 110 that has a front piece 116 that includes a mud ring 120 and integral structure mounts or brackets 122. The structure mounts 122 include holes 123 for securing the box 110 to a stud, an inter-stud bracket, or other structure, for example by the use of suitable fasteners, such as nails or screws. The front piece 116 is held to a box portion 124 by a series of clips 128 on the box portion 124. A back cover 140 may be used to seal the back of the box 110.

The box portion 124 surrounds and encloses a volume 144 between its front, where the front piece 116 forms the front of the box 110, and its back, where the back cover 140 closes off the back of the box 110. The volume 144 is rectangular in the illustrated embodiment, but alternatively the volume 144 may have other shapes, depending upon the shape of the box portion 124. The integral structure mounts 122 extend beyond a perimeter of the volume 144 that is enclosed by the box portion 124. The box portion 124 may be a single piece of material, bent to from the rectangular (or other) shape, with box portion sides 150, 152, 154, and 156, with ends of the single piece (strip) of material attached together at an attachment 158. The attachment 158 may involve overlapping and coupling the ends together, and may involve any of a variety of attachment processes, such as welding, staking, or riveting. The sides 150-156 may have suitable cutouts or knockouts 160, weakened and/or partially perforated removable sections, perhaps of various sizes, the removal of which allows entry and/or connection of electrical wires, cables, and connectors.

The box portion 124 has a pair of tabs, such as tab 162, that are folded over from the sides 150-156 of the box portion 124. The tabs 162 have holes in them for receiving fasteners, such as screws, used for mounting the back cover 140. The fasteners engage slots 166 and 168 in the back cover 140. The heads of the fasteners pass through the wide portions 170 and 172 of the slots 166 and 168, but not through the slot narrow portions 176 and 178. The back cover 140 can be put into engagement with the fasteners, and then twisted to prevent removal of the back cover 140.

The box portion 124 also has a ground connection 182, a folded-over tab of the box portion 124 used for grounding the box 110. The ground connection 182 may have a hole therein for receiving a suitable ground screw. A slot 184 in the back cover 140 allows the ground screw to extend rearward from the ground connection 182, and allows access to the ground connection 182 from outside of the box 110.

The front piece 116 has a series of slots 190 that receive the clips 128 on the box portion 124. The clips 128 are inserted into the slots 190, and then are folded over to secure the front piece 116 and the box portion 124 together. The position of the front piece 116 relative to that of the box portion 124 may be adjusted by use of the clips 128, such as by bending the clips at different places along their lengths.

Many of the features of the box 110 are common to other embodiments disclosed herein. Examples are the knockouts 160, the tabs 162 for engaging the back cover 140, and the ground connection 182.

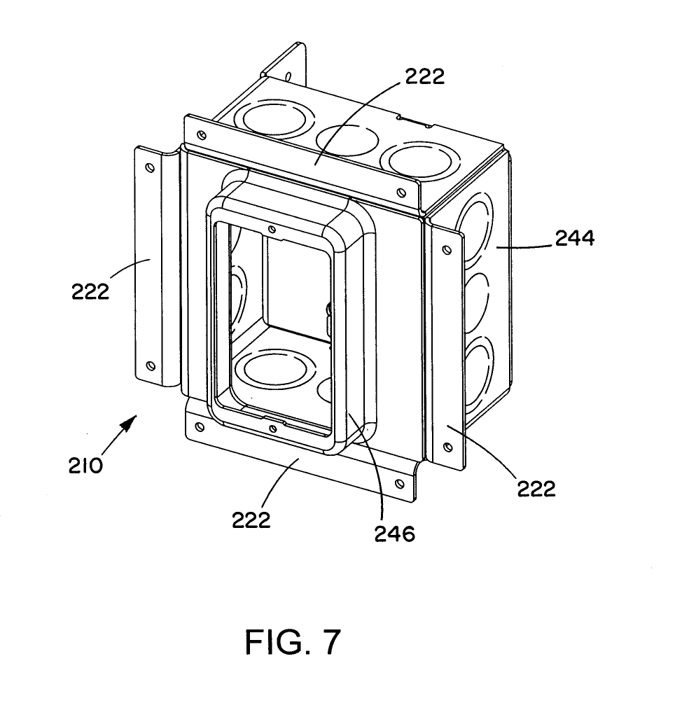

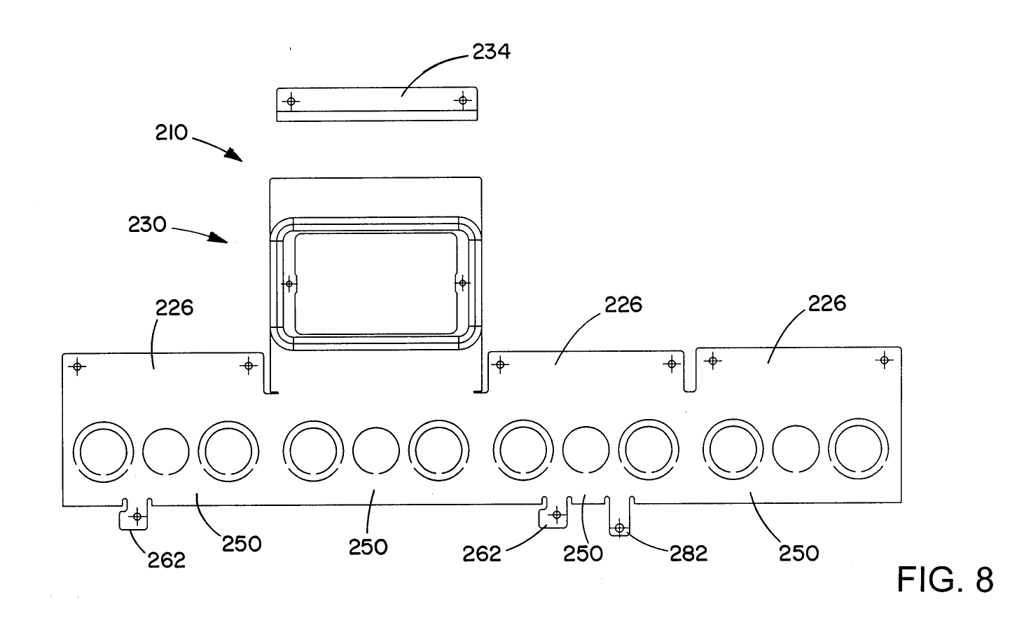

FIGS. 7 and 8 illustrate another box 210, wherein structure mounts or brackets 222 are adjustable for different levels of mounting. The structure mounts 222 include three integral structure mounts 226 that are parts of a blank 230, and can be bent at different points to provide different mounting locations for the box 210 relative to structure. A fourth of the structure mounts 222 is a separate bracket 234 that is attached to the box portion by fasteners, welding, material deformation, or other suitable joining processes.

The blank 230 also includes other parts of the box 210, including the box portion 244 and the mud ring 246. The box portion 244 and the mud ring 246 are thus integral parts of a unitary continuous piece of material (the blank 230), with of the box portion 244 and the mud ring 246 from the blank 230 done using suitable processes. For example, the mud ring 246 may be formed by suitable stamping operations. The box portion 244 may be formed by folding sides 250, the structure mounts 226, tabs 262, and ground connection 282. Ends of the box portion sides 250 may be attached as described elsewhere herein. Holes may be formed where needed by punching or drilling operations.

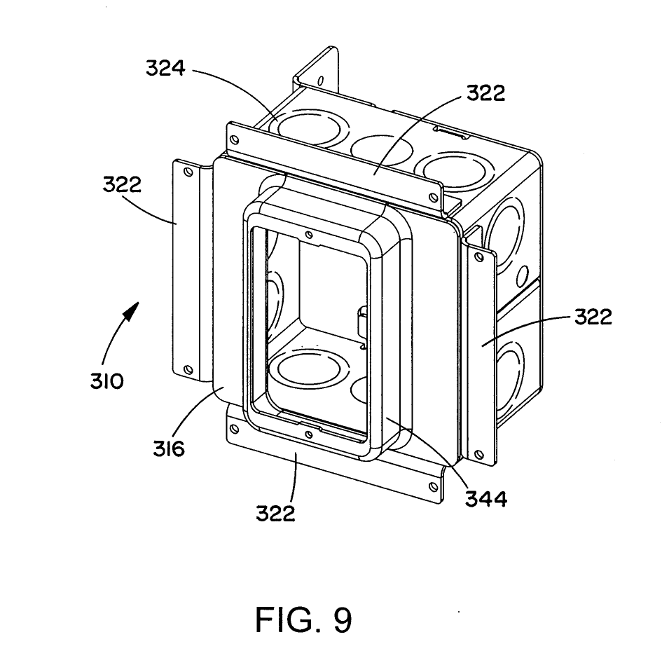

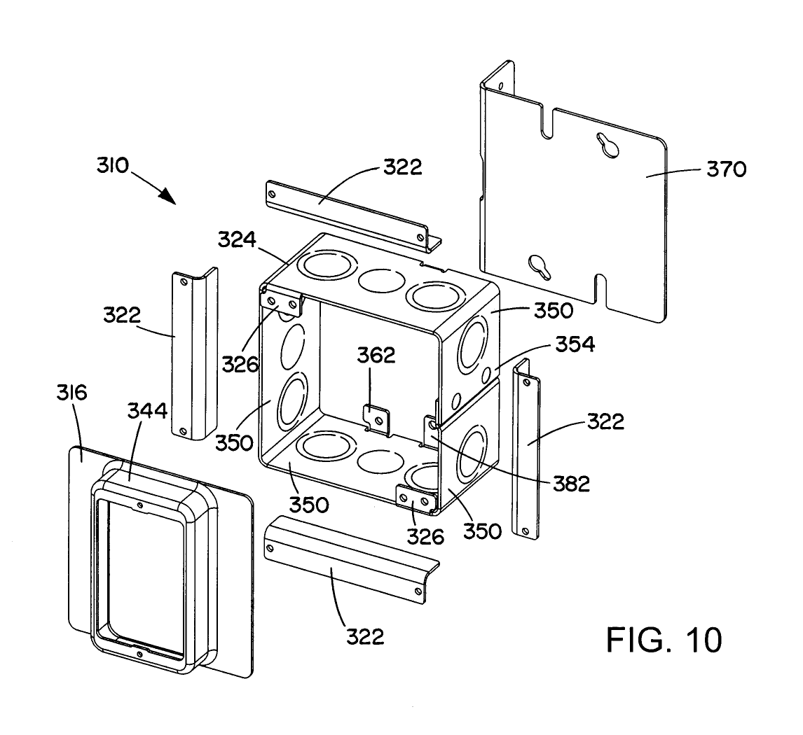

FIGS. 9 and 10 show another box 310, with a front piece 316 that attaches to a box portion 324 by spot welding or staking the front piece 316 to a pair of inwardly-bent tabs 326 of the box portion 324. Alternatively, the front piece 316 may be attached to the box portion 324 using fasteners or the like (not shown), which may allow the front piece 316 to be placed at various heights above the box portion 324. In addition, separate brackets 322 may be attached to the box portion 324 at any of a variety of different heights, by any of a variety of suitable mechanisms (such as those described in a previous paragraph).

The box 310 has many other features that are similar to those previously discussed with regard to other embodiments. The front piece 316 has a mud ring 344 for mounting a suitable electrical device. The box portion 324 has folded over sides 350 that are joined together at an attachment 354, with the tabs 326 being bent inward from opposite of the sides 350. Also bent inward from the sides 350 are tabs 362 for mounting a back cover 370, and a ground connection 382.

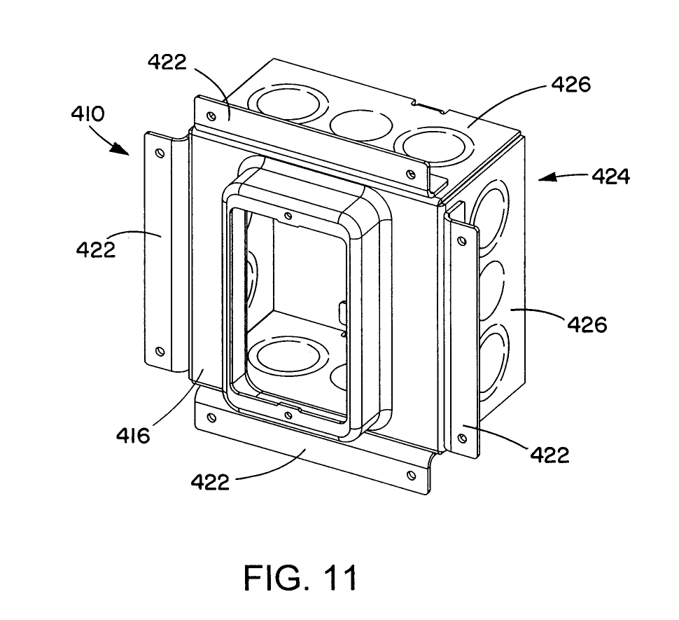

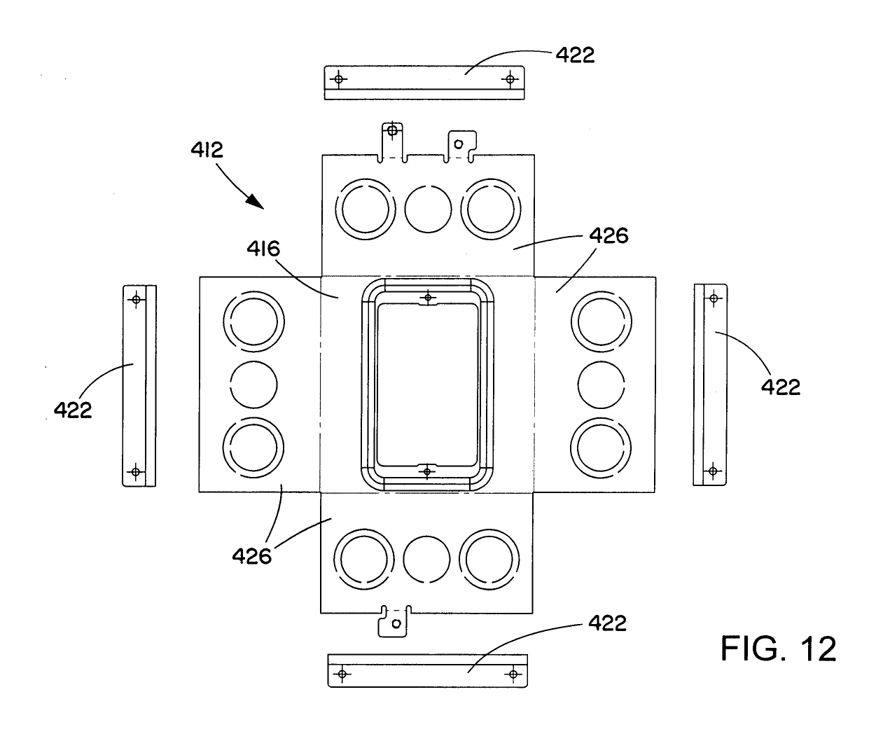

FIGS. 11 and 12 show another box 410, with a blank 412 (FIG. 12) used to form a unitary front piece 416 (with a mud ring 420) and a box portion 424, with the box portion 424 consisting of four separate side pieces 426. Brackets 422 are separated pieces that are attached to the side pieces 426 at any of a variety of different heights, by any of a variety of suitable mechanisms.

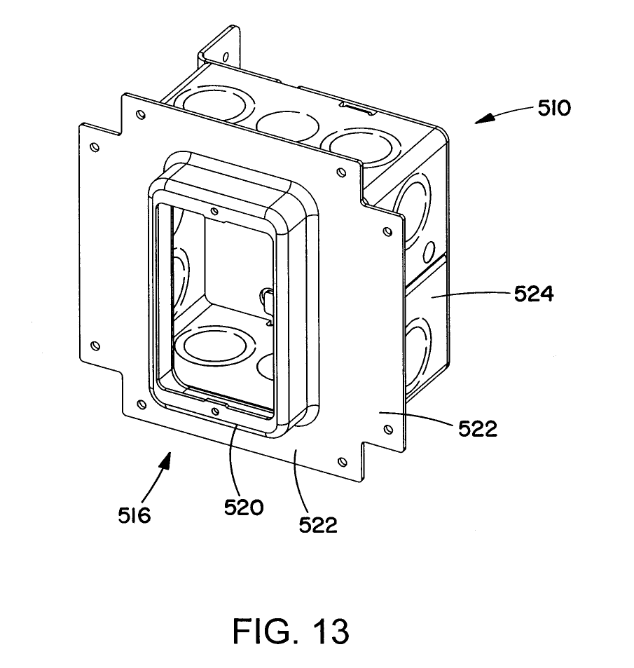

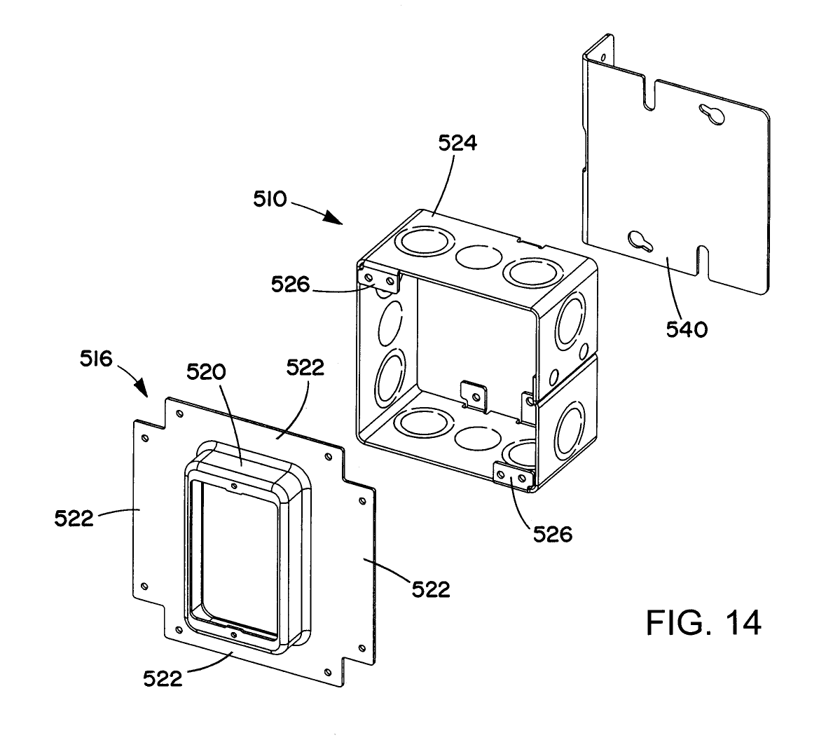

FIGS. 13 and 14 show a box 510 that combines features of the box 110 (FIG. 5) and the box 310 (FIG. 9). The box 510 includes a front piece 516 that includes a mud ring 520 and integral structure mounts 522. The front piece 516 may be similar to the front piece 116 (FIG. 5), with the exception that the front 516 does not have the clip-receiving slots 190 (FIG. 6). This is because the front piece 516 is coupled to box portion 524 in a manner similar to the coupling between the front piece 316 (FIG. 9) and the box portion 324 (FIG. 9). The box portion 524 may be substantially identical to the box portion 324, with inwardly-bent tabs 526 used for attaching the front piece 516 to the box portion 524 through suitable attachment processes, such as spot welding or staking. A back cover 540 may be similar to the back covers described in other embodiments, and may be coupled to the box portion 524 in the same way as the other box covers.

Advantages for some or all of the various embodiments described herein include the following: an open-back box with pre-installed devices saves time and labor at the jobsite by not tying up expensive electricians installing and wiring individual devices; the open back gives electricians direct access to wire connections without the time intensive removal of electrical devices, and the convenience of working through the large box back opening rather than the small mud ring opening; an integral mud-ring saves time and labor by allowing the device to be installed at the factory, not in the field; an integral mud ring reduces or eliminates the potential for spark gaps in the box/mud ring joint; an integral mounting bracket built in to the box provides a sturdier product that can more easily withstand the rigors of transit without incurring damage; the integral mounting bracket saves time and cost on stud mount installations by not requiring the installation of the box to a separate mounting bracket, which actually requires the installation of the entire assembly (box, device, mud-ring) through the bracket/mud-ring interface; the integral mounting bracket also saves time and cost on between-stud installations by allowing the assembly of the box directly to the surface of a floor-mount or between-stud bracket and not requiring the installation of a box to a separate mounting bracket, which actually requires the installation of the entire assembly (box, device, mud-ring) through the bracket/mud-ring interface; the ability to make adjustments in three dimensions means less inventory in warehouses and in vehicles stocking different depth mud-rings; the dual mounting tabs means you can mount on either side of the stud without disassembling the assembly and rotating the devices; the upper and lower tabs act as guide tabs allowing the assembly to attach to between stud mounting bracketry, or sideways mounting; and the AlObox is inspector-friendly, with fewer components in the assembly, making it easier for an inspector to confirm a proper installation (simpler is better).

One advantage of the second embodiment of the AlObox is that it allows for depth adjustment in and out of the wall cavity without intruding on the space inside the box itself. One shortcoming of current adjustable mud-rings is that, when fully retracted, they slide into the box cavity, limiting the space available for wiring as well as limiting access to the knockouts on the box.

The AlObox may be formed from stamped and folded sheet steel. While it is possible to stamp the entire AlObox (box, mounting brackets, and mud-ring) from the same strip of steel, it should be appreciated that there is likely to be a large waste of material in such a manufacturing method. As such, other methods of manufacturing are envisioned, such as stamping the open-back box with mounting brackets out of a single strip of steel, then permanently attaching the integral mud-ring via staking, welding, clinching, or some other suitable means of permanent attachment, or conversely, stamping the open-back box with integral mud ring out of a single strip of steel, then permanently attaching the integral brackets via staking, welding, clinching, or some other suitable means of permanent attachment.

As another possible variant, the opposing mounting tabs (or brackets) on the face of the AlObox may not all be the same size. One set of tabs might be larger and designed only to mount to the face of a wall stud, and the other set of tabs might be shorter and designed to allow for mounting inside the rails of an adjustable bracket (for either between stud installation or a floor-mounted installation). The tabs (brackets) may be integral to the box face, integral to the box side, or a combination of both.

It can be appreciated that there are a number of methods available to effect moving the AlObox (box portion) in and out of the wall cavity relative to a mounting bracket, such as: using fasteners to facilitate the depth adjustment of an integral mud-ring; using screws and/or springs to provide resistance during the depth adjustment; using a separate mounting flange that will attach to common bracketry and will serve as the mounting mechanism for the one-piece box with integral mud-ring; and/or using a sliding wedge driven by a threaded fastener to control the depth of an adjustable integral mud-ring.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. An electrical box comprising:
a box portion having an at least partially open back;
a mud ring non-threadedly coupled to a front of the box portion; and
one or more structure mounts mechanically coupled to the box portion and/or to the mud ring, and extending beyond a perimeter of a volume surrounded by the box portion.

2. The electrical box of claim 1, wherein the one or more structure mounts include at least one bracket that is a separate piece.

3. The electrical box of claim 2, wherein the at least one bracket is fixedly attached to the box portion.

4. The electrical box of claim 1, wherein the one or more structure mounts include mud ring extensions of the mud ring, with the mud ring extensions being integrally formed with the rest of the mud ring as a single continuous unitary piece of material.

5. The electrical box of claim 1, wherein the one or more structure mounts include structure mounts folded from sides of the box portion.

6. The electrical box of claim 5, wherein the structure mounts also include a bracket formed separately, and attached to one of the sides.

7. The electrical box of claim 1, wherein the box portion is at least 75% open in the back.

8. The electrical box of claim 1, wherein the box portion includes a ground connection.

9. The electrical box of claim 8, wherein the ground connection is an inward-folded tab of the box portion.

10. The electrical box of claim 1, wherein the mud ring is integrally formed with the box portion as a single continuous unitary piece of material.

11. The electrical box of claim 1, wherein the mud ring is fixedly attached to the box portion.

12. The electrical box of claim 11, wherein the mud ring is spot-welded to inwardly-bent tabs of the box portion.

13. The electrical box of claim 11, wherein the mud ring is secured to the box portion by clips on the box portion that pass through slots in the mud ring, and are bent over to secure the mud ring and box portion together.

14. The electrical box of claim 1, wherein the box portion includes sides that are folded portions of a single blank.

15. The electrical box of claim 14, wherein the mud ring is formed from the blank, with mud ring folded from one of the sides.

16. The electrical box of claim 14, wherein at least some of the structure mounts are parts of the blank, with the at least some of the structure mounts folded from respective of the sides.

17. The electrical box of claim 16, wherein the structure mounts also include a bracket formed separately from the blank, and attached to one of the sides.

18. The electrical box of claim 1, wherein the box portion includes that sides are joined together by staking or welding, fully surrounding a perimeter of the volume.

19. The electrical box of claim 1, wherein the box portion also includes folded-over tabs with holes, for receiving fasteners for mounting a back cover for covering the back of the box portion.

20. The electrical box of claim 19, further comprising:
the fasteners in the holes; and
the back cover, engaged with the fasteners.
